(19) United States
(12) Patent Application Publication
(10) Pub. No.: US 2019/0059360 A1
(43) Pub. Date: Feb. 28, 2019

(54) CRYOPRESERVATION OF CELLS IN ABSENCE OF VITRIFICATION INDUCING AGENTS

(71) Applicant: UNIVERSITY OF WARWICK, Coventry (GB)

(72) Inventors: Matthew I. GIBSON, Coventry (GB); Robert C. DELLER, Coventry (GB)

(21) Appl. No.: 16/018,555

(22) Filed: Jun. 26, 2018

Related U.S. Application Data
(63) Continuation of application No. 14/377,539, filed on Aug. 8, 2014, now abandoned.

(30) Foreign Application Priority Data
Feb. 8, 2012 (GB) 1202204.2
Sep. 28, 2012 (GB) 1217445.4

(51) Int. Cl. A01N 1/02

(52) U.S. Cl. CPC A01N 1/0221

(57) ABSTRACT

The present invention relates to a method for cryopreserving biological material. In particular, the method comprises storing the biological material at a cryopreserving temperature in a composition comprising polyvinyl alcohol (PVA), wherein the composition is substantially free of vitrification-inducing agents such as DMSO and glycerol. The invention also provides methods of inhibiting ice recrystallisation and of reducing cell damage during the warming or thawing of a cryopreserved composition comprising biological material. The invention also relates to processes for producing a biological material, and related kits.

The present invention relates to a method for cryopreserving biological material. In particular, the method comprises storing the biological material at a cryopreserving temperature in a composition comprising polyvinyl alcohol (PVA), wherein the composition is substantially free of vitrification-inducing agents such as DMSO and glycerol. The invention also provides methods of inhibiting ice recrystallisation and of reducing cell damage during the warming or thawing of a cryopreserved composition comprising biological material. The invention also relates to processes for producing a biological material, and related kits.

Cryopreservation is widely employed to increase the storage lifetimes of biological tissues and has the potential to improve the supply of donor cells/tissue/organs for transplantation or biotechnological applications, if freezing-induced damage can be reduced. In 1949, Polge et al. (C. Polge, A. U. Smith and A. S. Parkes, Nature, 1949, 164, 666) cryopreserved spermatozoa by replacing a significant quantity of water with a glass-forming organic solvent, in a process known as vitrification. Vitrification has also been extended to tissue storage, e.g. vascular grafts, but the major challenge is the removal of excess organic solvents post-thawing; these are often toxic and are used at very high concentrations. For example, 40 w/v % glycerol is currently used in North America to cryopreserve blood. Subsequent removal of cryoprotectants takes several days, whereas emergency transfusions require rapid availability. It has been suggested that a major cause of cell death during cryopreservation is actually the recrystallisation (growth) of ice crystals during thawing and that the presence of ice itself might not be fatal.

Antifreeze (glyco)proteins, AF(G)Ps from cold-acclimatised species are strong ice recrystallisation inhibitors (RI) and can improve the cryopreservation of blood. However, due to their secondary effect of dynamic ice shaping (DIS) which produces needle-like, membrane piercing ice crystals, only low concentrations of these proteins can be used, thus limiting their protective effect. AFGPs decreased cell viability during cryopreservation of rat hearts and mouse spermatozoa, and are indicated to be cytotoxic to human cells preventing their widespread application. Furthermore, AFGPs or close structural mimics are very challenging to obtain synthetically and so they must be extracted from polar fish in a process which is both expensive and time consuming. The desirable recrystallisation inhibition properties have been isolated from the undesirable ice shaping by a challenging synthesis of structurally simplified AFGPs. These peptides improved the cryoprotection of WRL-68 cells from ˜35 to 65% at 1.5 mg·mL⁻¹ but were less efficient than dimethyl sulfoxide and proved to be cytotoxic. Recently there has been interest in the use of synthetic polymers as mimics of AFGPs due to their (relatively) simple synthesis and highly tunable structure.

Polyvinyl alcohol (PVA) is known to have ice recrystallisation inhibitory properties similar RI to AFGPs, but is only weakly ice shaping and is non-toxic.

It has now been found that PVA can be used for cryopreservation without required vitrification, and in the absence of organic solvents such as DMSO and glycerol which are normally added to ensure successful vitrification, PVA is not cell penetrative and therefore is simple to remove post-cryopreservation.

Furthermore, it has now been found that when biological materials, e.g. cells, are frozen rapidly in non-vitreous solutions, the ice nucleation points remain small and numerous. Additionally, it has been found that, upon warming or thawing, if PVA is present in the composition, this prevents the natural recrystallisation of these small ice crystals into larger ones. (This is when a significant amount of cell death usually occurs.) In particular, it has been found that PVA not only has ice recrystallisation inhibitor (RI) activity but it also has the property of inhibiting ice crystal nucleation. Hence the presence of PVA during the warming or thawing of a frozen or cryopreserved biological material can significantly reduce damage to that material.

The use of PVA in this way facilitates a considerable reduction in the time between removal from the cryopreservation temperature to having transplant-ready cells by obviating the need for removal of organic solvents. It also avoids the use of toxic organic solvents thus increasing the safety of the cryopreservation process. PVA may also be used at considerably lower concentrations than the previously-used organic solvents. The invention is applicable to the cryopreservation of organs, tissues and cells, and particularly to cells such as red blood cells.

In one embodiment, therefore, the invention provides a method of cryopreserving biological material, comprising the step:
(i) storing the biological material at a cryopreserving temperature in a composition comprising PVA,
   wherein the composition is substantially free of vitrification-inducing agents.

The invention further provides a method of reducing cell damage in biological material which has been cryopreserved comprising the step:
(i) storing the biological material at a cryopreserving temperature in a composition comprising PVA, wherein the composition is substantially free of vitrification-inducing agents.

The invention further provides a method of reducing cell damage in biological material which has been cryopreserved comprising the steps:
(i) storing the biological material at a cryopreserving temperature in a composition comprising PVA, wherein the composition is substantially free of vitrification-inducing agents, and
(ii) thawing the biological material.

In a preferred embodiment, the PVA is present in the composition at a concentration which is insufficient to prevent ice nucleation in the composition.

In a further embodiment, the invention provides a method of inhibiting ice recrystallisation during the warming or thawing of a cryopreserved composition comprising biological material, the method comprising the step: (i) warming or thawing the cryopreserved composition comprising the biological material, wherein the composition comprises PVA, and wherein the composition is substantially free of vitrification-inducing agents.

The invention also provides a method of reducing cell damage during the warming or thawing of a cryopreserved composition comprising biological material, the method comprising the step: (i) warming or thawing the cryopreserved composition comprising the biological material, wherein the composition comprises PVA, and wherein the composition is substantially free of vitrification-inducing agents.

In a further embodiment, the invention provides a method of inhibiting ice recrystallisation during the warming or thawing of a cryopreserved composition comprising biological material, the method comprising the steps: (i) reducing the temperature of a composition comprising biological material to a cryopreserving temperature, wherein the composition comprises PVA, and wherein the composition is substantially free of vitrification-inducing agents, (ii) optionally storing the composition at the cryopreserving temperature, and (iii) warming or thawing the cryopreserved composition comprising the biological material.

In yet a further embodiment, the invention provides a method of reducing cell damage during the warming or thawing of a cryopreserved composition comprising biological material, the method comprising the steps: (i) reducing the temperature of a composition comprising biological material to a cryopreserving temperature, wherein the composition comprises PVA, and wherein the composition is substantially free of vitrification-inducing agents, (ii) optionally storing the composition at the cryopreserving temperature, and (iii) warming or thawing the cryopreserved composition comprising the biological material.

In some preferred embodiments, the cryopreserved composition comprises ice crystals. In other preferred embodiments, the temperature of the composition was or is reduced to the cryopreserving temperature at a rate which induced or induces the production of ice crystals in the composition.

In yet other embodiments, the temperature of the composition was or is reduced to the cryopreserving temperature at a fast rate.

As used herein, the terms “cryopreserving” or “cryopreservation” refer to the storage of biological material, e.g. cells, tissues or organs, at temperatures below 4° C. Generally, the intention of the cryopreservation is to maintain the biological material in a preserved or dormant state, after which time the biological material is returned to a temperature above 4° C. for subsequent use. Preferably, the cryopreserving temperature is below 0° C. For example, the cryopreserving temperature may be below −5° C., −10° C., −20° C., −60° C. or in liquid nitrogen or liquid helium, carbon dioxide (‘dry-ice’), or slurries of carbon dioxide with other solvents. In some preferred embodiments, the cryopreserving temperature is about −20° C., about −80° C. or about −180° C.

As used herein, the term “biological material” relates primarily to cell-containing biological material. The term includes cells, tissues, whole organs and parts of organs.

The cells which may be used in the methods or uses of the invention may be any cells which are suitable for cryopreservation. The cells may be prokaryotic or eukaryotic cells. The cells may be bacterial cells, fungal cells, plant cells, animal cells, preferably mammalian cells, and most preferably human cells. In some embodiments of the invention, the cells are all of the same type. For example, they are all blood cells, brain cells, muscle cells or heart cells.

In other embodiments, the biological material comprises a mixture of one or more types of cell. For example, the biological material may comprise a primary culture of cells, a heterogeneous mixture of cells or spheroids.

In other embodiments, the cells are all from the same lineage, e.g. all haematopoietic precursor cells.

The cells for cryopreservation are generally live or viable cells or substantially all of the cells are live or viable. In some embodiments, the cells are isolated cells, i.e. the cells are not connected in the form of a tissue or organ.

In some preferred embodiments, the cells are adipocytes, astrocytes, blood cells, blood-derived cells, bone marrow cells, bone osteosarcoma cells, brain astrocytoma cells, breast cancer cells, cardiac myocytes, cerebellar granule cells, chondrocytes, corneal cells, dermal papilla cells, embryonal carcinoma cells, embryo kidney cells, endothelial cells, epithelial cells, erythroleukaemic lymphoblasts, fibroblasts, foetal cells, germinal matrix cells, hepatocytes, intestinal cells, keratocytes, kidney cells, liver cells, lung cells, lymphoblasts, melanocytes, mesangial cells, meningeal cells, mesenchymal stem cells, microglial cells, neural cells, neural stem cells, neuroblastoma cells, oligodendrocytes, oligodendroglioma cells, oocytes, oral keratinocytes, organ culture cells, osteoblasts, ovarian tumour cells, pancreatic beta cells, pericytes, perineurial cells, root sheath cells, schwann cells, skeletal muscle cells, smooth muscle cells, sperm cells, stellate cells, synoviocytes, thyroid carcinoma cells, villous trophoblast cells, yolk sac carcinoma cells, oocytes, sperm or embryoid bodies: or any combination of the above. In other embodiments, the cells are stem cells, for example, neural stem cells, adult stem cells, iPS cells or embryonic stem cells. In some preferred embodiments, the cells are blood cells, e,g. red blood cells, white blood cells or blood platelets.

In some particularly preferred embodiments, the cells are red blood cells which are substantially free from white blood cells and/or blood platelets.

In other embodiments, the biological material to be cryopreserved is in the form of a tissue or a whole organ or part of an organ. The tissues and/or organs and/or parts may or may not be submerged, bathed in or perfused with the composition prior to cryopreservation. Examples of tissues include skin grafts, corneas, ova, germinal vesicles, or sections of arteries or veins. Examples of organs include the liver, heart, kidney, lung, spleen, pancreas, or parts or sections thereof. These may be of human or non-human (e.g. non-human mammalian) origin.

In some preferred embodiments, the biological material or cells are selected from semen, blood cells (e.g. donor blood cells or umbilical cord blood, preferably human), stem cells, tissue samples (e.g. from tumours and histological cross sections), skin grafts, oocytes (e.g. human oocytes), embryos (e.g. those that are 2, 4 or 8 cells when frozen), ovarian tissue (preferably human ovarian tissue) or plant seeds or shoots.

The biological material may be living or dead (i.e. non-viable) material. The biological material is contacted with the composition comprising PVA.

In general, the biological material will be immersed or submerged in the composition or perfused with the composition such that the composition makes intimate contact with all or substantially all of the biological material.

The composition comprises polyvinyl alcohol (PVA). This PVA will in general be added to the composition prior to cryopreservation of the biological material.

As used herein, the term “PVA” refers to polyvinyl alcohol, i.e. (CH₂CHOH)ₙ wherein n>2, or a derivative thereof or a co-polymer comprising PVA. PVA is commercially available (e.g. Aldrich) in a variety of different molecular weights and degrees of hydrolysis.

The weight average molecular weight of the PVA may be from 1 kDa to 200 kDa, Examples of preferred PVA ranges include those comprising PVA having a weight average molecular weight in the following ranges: 1-5 kDa, 5-10 kDa, 7 to 15 kDa, 10-15 kDa, 15-20 kDa, 20-25 kDa, 25-30 kDa, 30-35 kDa, 35-40 kDa, 40-50 kDa, 50-60 kDa, 60-70 kDa, 70-80 kDa, 80-90 kDa, 90-100 kDa, 100-120 kDa, 120-140 kDa, 140-160 kDa, 160-180 kDa or 180-200 kDa. Other preferred weight average molecular weights are 1-80 kDa and 1-50 kDa.

In some preferred embodiments of the invention, the PVA may have a weight average molecular weight of about 1, 2, 3, 4, 5, 6, 7, 8, 9, 10, 11, 12, 13, 14 or 15 kDa. In some other preferred embodiments of the invention, the PVA may have a weight average molecular weight in the range 6-14 kDa, preferably 7-13 kDa, more preferably 8-12 kDa or 9-11 kDa, and most preferably about 10 KDa.

The PVA may be partially hydrolysed, e.g. 80-100% hydrolysed, 90-100% hydrolysed, 98-99% hydrolysed; at least 75, 80, 85, 90, 95 or 99% hydrolysed; or 87-89% hydrolysed. PVAs which are not 100% hydrolysed may also be described as PVA co-poly(vinyl acetate). The PVA may be atactic, syndiotactic or isotactic.

The PVA may be part of a copolymer, e.g. a copolymer with vinyl acetate, ethyl vinyl acetate and/or propyl vinyl acetate.

The concentration of PVA in the composition will generally be in the range 0.1 mg/mL to 50 mg/ml, preferably 0.5 mg/mL to 10 mg/mL and more preferably 0.7 mg/mL to 5 mg/mL. In some embodiments, the concentration of PVA in the composition is 0.5 mg/mL to 2.5 mg/mL, preferably about 1.0 or 1.5 mg/mL. The above concentrations include concentrations which are insufficient to prevent ice nucleation in the composition.

In some particularly preferred embodiments, the PVA has a weight average molecular weight in the range 7-13 kDa and it is used in the composition at a concentration of 0.5 mg/mL to 2.5 mg/mL. In one particularly preferred embodiment, the PVA has a weight average molecular weight of about 10 kDa and it is used in the composition at a concentration of about 1 mg/mL.

Derivatives of PVA within the scope of the invention include alkyl/aryl ester substituted PVA.

The composition may additionally comprise one or more of the following:
a buffer, e.g. PBS
an antibiotic
an anticoagulant
an antioxidant
a pH indicator.

In most embodiments, the composition is an aqueous composition or substantially an aqueous composition.

The composition may also comprise small amounts of organic solvents such as DMSO or glycerol but in amounts that are insufficient to promote or induce vitrification.

As used herein, the term “vitrification” refers to the creation of a non-crystalline glass-phase solid from a liquid. Glass formation is a second order phase transition in which the specific heat and viscosity of the substance change significantly.

For pure water, glass forms at −138° C., but glass phase water cannot ordinarily be formed because ice crystals form at temperatures much higher than this. Vitrification can be achieved at higher temperatures, however, by adding vitrification inducing agents which inhibit the formation of ice crystals.

The composition is substantially free of vitrification-inducing agents. A “vitrification-inducing agent” is one which is capable of inducing vitrification in the composition at a cryopreserving temperature, e.g. at −20° C. or at the temperature of liquid nitrogen or dry ice. The presence or absence of vitrification of the composition may be established by differential scanning calorimetry and cryomicroscopy. Examples of vitrification-inducing agents include ethylene glycol, glycerol, DMSO and trehalose. In some embodiments, the term “vitrification-inducing agents” includes glass-forming organic solvents. e.g. dials and trials. In other embodiments, the term “vitrification-inducing agents” includes propylene glycol, polyethylene glycol and dextran.

As used herein, the term “substantially free of vitrification-inducing agents” means that the composition is not capable of forming a non-crystalline glass-phase. In general, vitrification-inducing agents are substantially absent from the composition or no vitrification-inducing agents are added to the composition.

The cryopreserved composition is in a non-vitreous state. As used herein, the term “non-vitreous state” means that the composition is not in a non-crystalline glass state.

In some embodiments, the cryopreserved biological material has not been supercooled to its cryopreserving temperature. As used herein, the term “not supercooled” means that the temperature of the composition was not lowered to below its freezing point without it at least starting to become a solid, i.e. without ice crystals starting to form.

The method of the invention may additionally comprise the step of cryopreserving or freezing the biological material. The freezing of the biological material may take place in the composition or before the biological material is contacted with or placed in the composition. In other words, the biological material may be frozen before it is contacted with the composition. As used herein, the term “freezing” or “frozen” refers to reducing the temperature to a cryopreserving temperature or being at a cryopreserving temperature.

The method of the invention may additionally comprise the step of thawing the composition. In some embodiments, the term “thawing” refers to raising the temperature of the cryopreserved composition or biological material to 0° C. or above, preferably to 4° C. or above. In other embodiments, the term “thawing” refers to raising the temperature of the composition or biological material to a temperature at which there are no or substantially no ice crystals in all or part of the composition or biological material. Hence the term “thawing” includes complete and partial thawing.

The term “recrystallisation” is known in the context of cryopreservation to refer to ice crystal growth during warming or thawing.

The biological material may subsequently be isolated or removed from the composition.

In general, the biological material will be placed in the composition and then the temperature will be reduced. It may be reduced directly to the final cryopreserving temperature or first to an intermediate temperature (which may be above or below the final cryopreserving temperature).

The rate of this freezing step may, for example, be slow (e.g. 1-10° C./minute), or fast (above 10° C./min). In some embodiments, the rate of freezing is at least 10° C./minute, preferably at least 20° C./minute, at least 50° C./minute or at least 100° C./minute. In some embodiments, the rate of freezing is between 10° C./minute and 1000° C./minute, between 10° C./minute and 500° C./minute, or between 10° C./minute and 100° C./minute.

The invention is based, at least in part, on the finding that fast rates of freezing induce the production of ice crystals in the composition. Crystals produced in this way are small; they are also generally numerous. Upon warming or thawing of the cryopreserved composition, it has been found that the presence of PVA in the composition inhibits the natural recrystallisation of these small ice crystals into larger ones, thus significantly reducing the cell death which would normally occur at this time.

The most preferred freezing rate in any one particular case will be dependent on the volume of the composition and the nature of the biological material. By following the teachings herein and the above points in particular, the skilled person may readily determine the most appropriate freezing rate in any one case.

In general, the composition comprising the biological material will initially be at a temperature about 0° C., e.g. at about 4° C. or at ambient temperature. From there, its temperature will be reduced to the cryopreserving temperature, preferably in a single, essentially uniform step (i.e. without a significant break).

Rapid freezing using solid CO₂ slurries or liquid N₂ are preferred, which cool at approximately 100° C./min. It is also possible to achieve similar rates using other cryogens which have a temperature which is colder than standard refrigerators (e.g. below −20° C.).

Preferably, the composition comprising the biological material is not stirred and/or is not agitated during the freezing step.

The rate of thawing may, for example, be slow (e.g. 1-10° C./minute) or fast (above 10° C./min). In some cases it may be advantageous to thaw slowly. Rapid thawing in a water bath at 37° C. is preferred. Cell recovery is also possible at lower temperatures (e.g 20° C.).

Alternatively, the temperature of the biological material may be raised to a temperature at which the biological material may be removed from or isolated from the composition (e.g. 4° C. or above); and the biological material may then be stored at this temperature until use.

In a preferred embodiment, the PVA is present in the composition at a concentration which is insufficient to prevent ice nucleation (ice formation) in the composition. Under such circumstances, ice may form in the composition.

The invention therefore provides a method as described herein, wherein ice is present in the composition at one or more stages during thawing of the composition.

Ice nucleation within the composition may be tested for by differential scanning calorimetry or cryomicroscopy.

In some embodiments, the composition is cryopreserved at a rate which induces the production of ice crystals, most preferably small ice crystals, in the cryopreserved composition. As used herein, the term “small ice crystals” means that the ice crystals are less than than 100 μm in length, more preferably less than 50 μm in length, and most preferably less than 25 μm, less than 20 μm, less than 10 μm or less than 5 μm in length. Length refers to the longest dimension of the ice crystal. Preferably, at least 80% of the ice crystals in the cryopreserved composition are less than 50 μm in length. Most preferably, at least 90% of the ice crystals in the cryopreserved composition are less than 20 μm in length. Most preferably, at least 95% of the ice crystals in the cryopreserved composition are less than 10 μm or less than 5 μm in length. The percentages of ice crystals in the frozen composition having less than a specified size may be determined by optical or electron microscopy.

The composition preferably does not contain haemolytic agents, e.g. agents which induce the lysis of red blood cells.

The cryopreserved biological material may be stored for cell, tissue and/or organ banking.

The cryopreserved material may be stored at the cryopreserving temperature for any desired amount of time. Preferably, it is stored for at least one day, at least one week or at least one year. More preferably, it is stored for 1-50 days, 1-12 months or 1-4 years. In some embodiments, it is stored for less than 5 years.

After cryopresevation, the biological material may be used for any suitable use, including human and veterinary uses. Such uses include for tissue engineering, gene therapy and cellular implantation.

The invention further provides a process for producing a cryopreserved composition comprising biological material, comprising the step:
(i) freezing a biological material at a cryopreserving temperature in a composition comprising PVA, wherein the composition is substantially free of vitrification-inducing agents.

The invention further provides a process for producing a biological material, comprising the steps:
(i) freezing a biological material at a cryopreserving temperature in a composition comprising PVA, wherein the composition is substantially free of vitrification-inducing agents,
(ii) thawing the composition comprising the biological material and PVA, and optionally removing and/or isolating the biological material from the composition.

The process may additionally comprise the step of storing the biological material at a temperature of 0-10° C. after thawing.

The invention further provides a process for producing a biological material, comprising the steps:
(i) freezing a biological material at a cryopreserving temperature in a composition comprising PVA, wherein the composition is substantially free of vitrification-inducing agents, and optionally subsequently raising the temperature of the biological material (e.g. to above 0 or 4° C.),
(ii) removing and/or isolating the biological material or part thereof from the composition, and
(iii) storing the biological material at a temperature of 0-10° C.

In yet a further embodiment, the invention provides a cryopreserved composition comprising:
(i) PVA, and
(ii) a biological material,
   wherein the composition is substantially free of vitrification-inducing agents.

The cryopreserved composition may additionally comprise one or more of the following:
a buffer, e.g. PBS
an antibiotic
an anticoagulant
an antioxidant
a pH indicator.

The cryopreserved composition may also comprise small amounts of organic solvents such as DMSO or glycerol but in amounts that are insufficient to promote or induce vitrification.

Preferably, the cryopreserved composition is frozen, e.g. at a temperature of less than 0° C., more preferably less than −5° C., −20° C. or −60° C.

The invention further provides a kit comprising:
(i) PVA, and
(ii) instructions for use of the PVA in a cryopreservation method of the invention or wherein a biological material is cryopreserved in a composition comprising PVA in the absence of vitrification-inducing agents.

### BRIEF DESCRIPTION OF THE FIGURES

FIG. 1. Recrystallisation inhibition activity of polymers.

(A) Example micrographs showing polynucleated ice (PBS) wafers with and without 5 mg·mL⁻¹ PVA 9 kDa after annealing at −6° C. for 30 minutes.

(B) Quantitative evaluation of the mean largest grain size (MLGS) as a function of polymer and concentration, relative to PBS control (average of at least 3 measurements).

(C) Structures of PVA, PEG and dextran.

FIG. 2. Recrystallisation inhibition activity of polymers.

Quantitative evaluation of the mean largest grain size (MLGS) as a function of polymer and concentration, relative to PBS control (average of at least 3 measurements).

FIG. 3. Haemolysis of erythrocytes following incubation with indicated polymers for 120 minutes at 25° C.

FIG. 4. Effect of PVA 9 kDa on the recovery of red blood cells post-freezing. Images show red blood cells at 200× magnification.

FIG. 5. Erythrocyte recovery (non-lysed cells) following freezing at −76° C. and slow thawing. Average of at least 5 measurements. * indicates statistical difference using Student's p test.

FIG. 6. Erythrocyte haemolysis following slow freezing and variable thawing conditions. Results are average of at least 5 measurements.

FIG. 7. Ice crystals at 40× magnification. Black dots are ice crystals. Scale bar=500 microns.

FIG. 8. Rapid cooling gives smaller crystals. Scale bar=100 μm.

### EXAMPLES

The present invention is further illustrated by the following Examples, in which parts and percentages are by weight and degrees are Celsius, unless otherwise stated. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usages and conditions. Thus, various modifications of the invention in addition to those shown and described herein will be apparent to those skilled in the art from the foregoing description. Such modifications are also intended to fall within the scope of the appended claims.

The disclosure of each reference set forth herein is incorporated herein by reference in its entirety.

Materials and Methods

Ice Recrystallisation Inhibition (IRI) Assay

Determination of RI activity was achieved using a modified “splat” assay. A 10 μL droplet of the analyte solution in PBS was expelled at a fixed height of 2 m onto a glass coverslip placed upon a pre-cooled (CO₂₍ₛ₎) aluminium plate. This was immediately transferred onto the pre-cooled microscope stage (−6° C.) and left to anneal for 30 minutes. Photographs of the wafer were taken at both 0 and 30 minutes through crossed polarizers. A large number of the ice crystals (30+) were then measured to find the largest grain size dimension along any axis. The average largest value from 3 individual photographs was calculated to give the mean largest grain size (MLGS). Reported errors are the coefficient of variation (standard deviation/mean) from a minimum of 3 individual data sets. Values are reported as the MLGS relative to that obtained for PBS alone.

Cryopreservation by Fast-Freezing and Slow Thaw.

Samples were prepared in quintuplet. A 500 μL aliquot of prepared erythrocytes was added to 500 μL of cryoprotectant in PBS and mixed by inversion. Each sample was then rapidly frozen in an isopropanol/CO₂ bath (−78° C.) for 30 seconds and subsequently stored over solid CO₂ for 20 minutes. Samples were allowed to thaw at 25° C. for 60 minutes before haemolysis was measured.

Materials.

9 KDa PVA (average Mw 9,000-10,000, 80% hydrolyzed), 31 KDa PVA (average Mw 31,000-50,000, 98-99% hydrolyzed), 85 KDa PVA (average Mw 85,000-124,000, 99+% hydrolyzed), 8 KDa PEG (average Mw 8,000), 100 KDa PEG (average Mw 100,000), 40 KDa Dextran (average Mw 40,000 obtained from Leuconostoc spp) were sourced from Sigma-Aldrich UK and used as supplied unless specified. Ultrahigh quality water with a resistance of 18.2 MΩcm (at 25° C.) was obtained from a Millipore Milli-Q gradient machine fitted with a 0.22 mm filter. Preformulated, powdered, phosphate buffered saline was purchased from Sigma-Aldrich and the desired solution made by addition of ultrahigh quality water to give [NaCl]=0.138 M, [KCl]=0.0027 M and pH 7.4. Dialysis membranes with MWCO=1000 were purchased from Spectrum Laboratories Inc, CA, USA. A Hamilton gastight 1750 syringe (Hamilton Bonaduz AG, GR, Switzerland) coupled with a BD microlance 3 21 G needle (BD, Oxford, UK) was used for to prepare ice wafers (see below). No. 1 thickness glass coverslips 22×22 mm were used for ice wafer preparation (Erie Scientific, NH, USA). Fresh ovine (defibrinated) erythrocytes were supplied by TCS Biosciences Ltd UK. 1.5 mL Eppendorf tubes were used for the fast freezing process and cryoprotectant toxicity assessment. 2.0 mL Cryovials (Corning B.V. Life Sciences, Amsterdam, The Netherlands) were used for the slow-freezing processes.

Physical and Analytical Methods.

An Olympus CX41 microscope equipped with a UIS-2 20×/0.45/∞/0-2/FN22 lens (Olympus Ltd, Southend on sea, UK) and a Canon EOS 500D SLR digital camera were used to obtain all images. Image processing was conducted using Image J, which is freely available from http://imagej.nih.gov/ij/. For cryomicroscopy a nanolitre osmometer (Otago Osmometers Ltd, Dunedin, New Zealand) was used to provide a constant annealing temperature. UV-visible measurements were performed in sero-wel 96-well plates (Bibby-sterlin Ltd, Staffordshire, UK) using a Multiskan ascent plate reader (Thermo-scientific Ltd, Hampshire, UK).

Statistics and Calculations.

All statistics and calculations were determined using Microsoft® Excel® 2008 for Mac. Significance determination for the RI data utilized a two-tailed homoscedastic student's t-test with a 99% confidence interval. This showed at all concentrations tested a significant difference in MLGS between 9 KDa PVA and 31 KDa PVA with PBS. Conversely no significant difference in MLGS was present between 8 KDa PEG, 100 KDa PEG and dextran with PBS. This supports the conclusion that PVA significantly inhibits ice recrystallisation and that its isomer PEG and the cryoprotectant dextran do not. Significance determination for the cryopreservation data also utilized a two-tailed homoscedastic Student's t-test but with a 95% confidence interval (an acceptable value for biological data). This revealed that at the most potent concentration (2 mg·mL⁻¹) of 9 kDA PVA, the observed recoveries of cells were statistically significant.

Polymer Preparation. Before use all polymers were purified by dialysis against 3000 MWCO membranes to remove any small molecule contaminants. PVA and PEG samples were prepared by dissolving 500 mg in 10 mL DMSO before dialysing against 4 L H₂O with at least 5 changes of the water at regular intervals. The dialysed samples were then rotary evaporated down to a volume approximating 5 mL before being freeze dried under vacuum. Samples were then diluted in PBS to the final concentrations required.

Erythrocyte Preparation. The as-supplied Erythrocyte suspension was centrifuged (1950×g, 5 min, 25° C.) and the top layer (containing any plasma and its constituents) removed and replaced with an equivalent volume of PBS. When not in use Erythrocytes were stored in this form at 4° C. for a maximum of 7 days.

Cryopreservation by Slow-Freezing and Variable Thawing Rates. A 500 μL aliquot of erythrocytes was added to 500 μL of the cryoprotectant in PBS and mixed by inversion. The erythrocytes were then slow cooled from room temperature at 4° C. for 120 minutes then transferred to −20° C. for a further 240 minutes. The erythrocytes were finally placed at −84° C. overnight. Erythrocytes were either slow thawed at room temperature for 60 minutes or rapidly thawed (preventing significant ice recrystallisation) at 42° C. for 15 minutes prior to analysis. All experiments were repeated a minimum of five times.

Measurement of Erythrocyte Haemolysis. A 40 μL aliquot of the thawed erythrocyte solution was added to 400 μL PBS and centrifuged (1000×g, 5 min, 4° C.) to remove intact cells. 50 μL of the supernatant was added to 150 μL PBS in a 96-well plate and an absorbance measurement at 450 nm recorded to assess the extent of haemoglobin leakage. 100% haemolysis samples were prepared by osmotic shock through addition of 500 μL H₂O to 500 μL erythrocytes suspension and the sample was vortexed vigorously. Control (0% haemolysis) samples were prepared by the addition of 500 μL PBS to 500 μL erythrocytes and left at room temperature (25° C.) for 60 minutes. All measurements were repeated a minimum of 5 times and the reported errors are the coefficient of variation (standard deviation/mean).

% Haemolysis was determined using Equation 1:

% Haemolysis=100%. ((I_{Thaw}−I_{Background})/I_{water})

Cell recovery was estimated using Equation 2:

Cell recovery=100−% Haemolysis

Assessment of Cryoprotectant Haemocompatibility, Erythrocytes were prepared as described above. A 500 μL aliquot of erythrocytes was added to 500 μL of the polymer or DMSO in PBS and mixed by inversion. The samples were incubated at 25° C. for 120 minutes before analysis. Haemolysis was measured in the same method as used for cryopreservation studies (above). All measurements were repeated in triplicate.

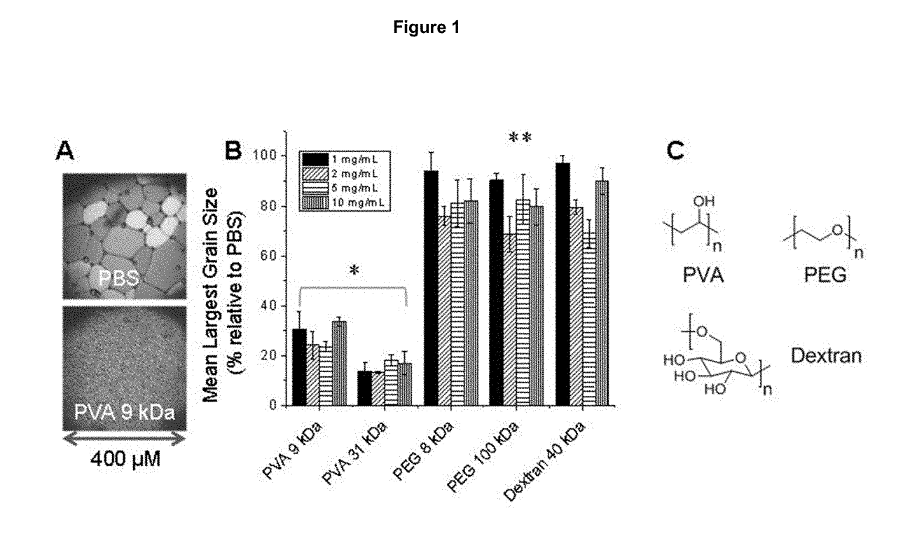

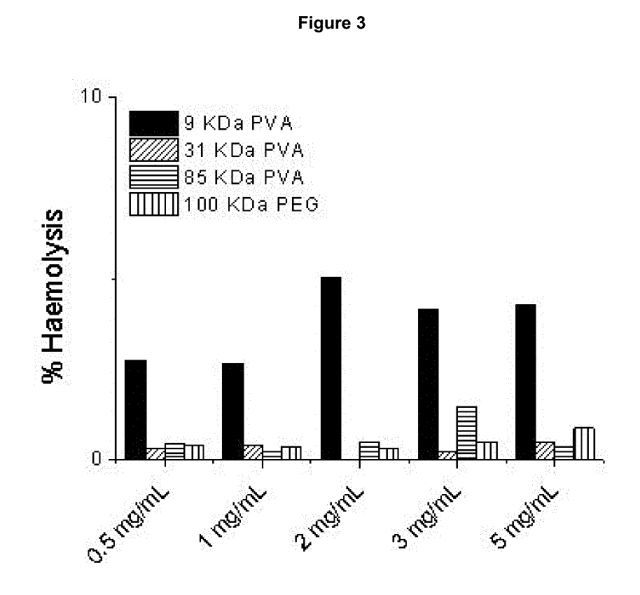

Cytotoxicity Testing. Fresh ovine (defibrinated) erythrocytes were prepared in an identical manner as aforementioned. Samples were prepared in triplicate. A 500 μL aliquot of erythrocytes was added to 500 μL 2× final concentration cryoprotectant in PBS and mixed by inversion. The samples were incubated at room temperature for 120 minutes before analysis. The maximum concentrations assessed that did not yield significant haemolysis (>5%) were equal to the highest concentrations used for cryopreservation (FIG. 1). This is in contrast to some examples that defined toxicity only at levels exceeding 10% haemolysis. Concentrations higher than this were not deemed necessary for assessment. The impact of DMSO on haemolysis was also evaluated and shown in FIG. 3. Above 1.5 wt % (which is significantly below the concentration required for vitrification), significant haemolysis was observed.

### Example 1

### Ice Recrystallisation Inhibition Activity of PVA

To demonstrate the specific ice recrystallisation inhibition (IRI) activity of PVA, a modified ‘splat’ assay was conducted. A polynucleated wafer of ice crystals (each ice crystal is <30 μm) was made from phosphate buffered saline (PBS) solutions of the additive being investigated. Following annealing at −6° C. for 30 minutes, the wafers were imaged through crossed polarisers and the size of the crystals measured. In addition to PVA, two common biocompatible polymers were also assed for IRI activity; dextran and polyethylene glycol) (PEG, FIG. 1C), as they are both commonly added to cryopreservative solutions.

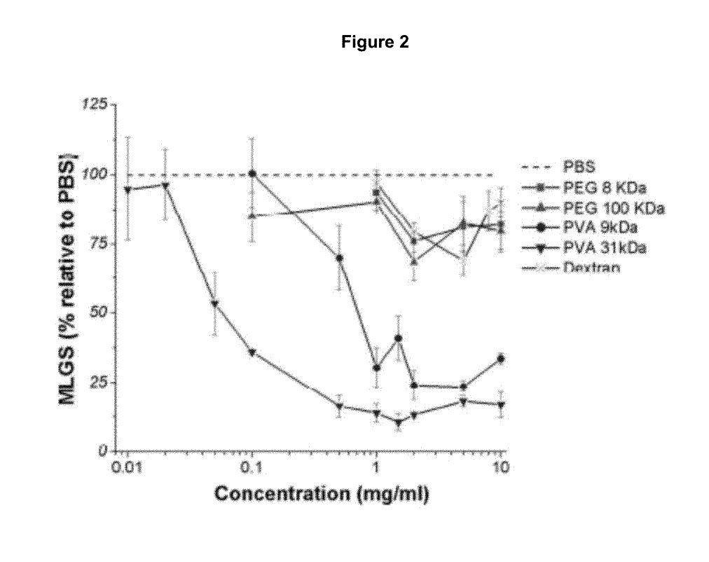

Example ice-wafers obtained following annealing for 30 minutes are shown in FIG. 1A. The mean largest grain size (MLGS) of the crystals is reported relative to a PBS control. FIG. 1B shows that PVA completely arrests the growth of ice crystals when used in 1-10 mg·mL⁻¹ concentration range. Conversely, neither PEG nor dextran had any effect on ice crystal growth even at 10 mg·mL⁻¹. Our previous study indicated that IRI activity is rare in synthetic polymers and there are no current tools to predict activity. 31 kDa PVA appeared to be slightly more potent than 9 kDa and continues to function as an inhibitor at lower concentrations (FIG. 2). This data serves to highlight the specific activity of PVA and the major challenges associated with identification of new macromolecules with this property, which is exacerbated by a lack of fundamental understanding of the inhibition process and the structural motifs required for activity. It is worth highlighting that the other ‘antifreeze’ properties (DIS and TH) have been extensively investigated in several detailed studies, but IRI activity is often ignored. Common vitrification solvents, such as DMSO and glycerol show little or no IRI activity at these concentrations.

### Example 2

### Cryopreservation Using PVA

The ability of the polymers to improve cryopreservation was tested. Red blood cells (erythrocytes) were chosen as they are readily available and there is a real medical need to improve their long term storage. Standard haemolysis assays indicated that all of the polymers used in this study are non-haemolytic and do not induce agglutination and can therefore be considered to be biocompatible with red blood cells.

The effect of polymers on haemolysis of the red blood cells relative to a positive control (osmotic shock with pure water) is shown in FIG. 3. All polymers, at all concentrations tested showed less than 5% haemolysis and can therefore be considered haemocompatible for the purposes of this study. For comparison, DMSO (dimethylsulfoxide) was also tested with the red blood cells. Above 1.5 w/v %, significant haemolysis was observed, which is still well below the concentration required to achieve cryoprotection by vitrification.

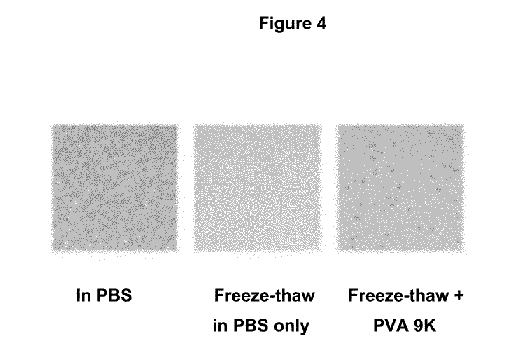

In contrast, some common cryoprotectants such as DMSO are strongly haemolytic and even glycerol which is routinely employed leads to some haemolysis. FIG. 4 shows example micrographs of red blood cells in PBS buffer before and after freezing with either no additive or with 5 mg·mL⁻¹ PVA (9 kDa). Clearly there are no intact cells in the PBS-freeze-thawed sample, but significant numbers of cells are recovered in the PVA (9 kDa) containing sample. This qualitatively demonstrates that polymers with specific IRI activity can augment cryopreservation.

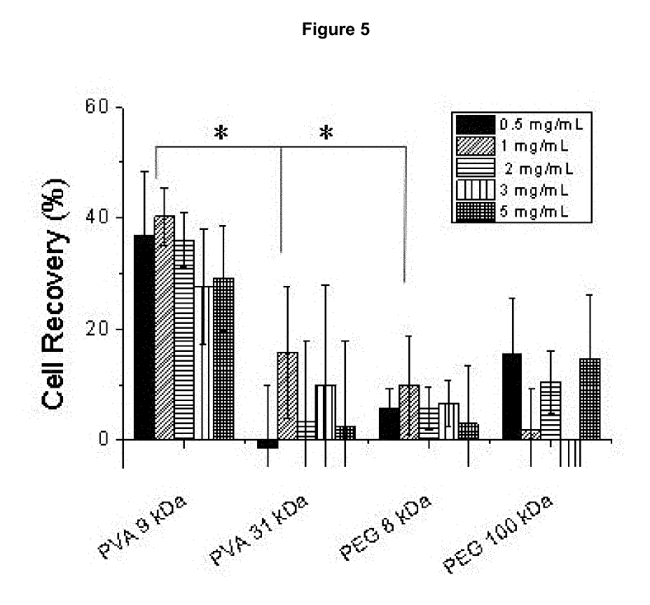

Haemolysis assays were undertaken to quantify cell recovery post-freezing. Red blood cells were directly frozen in a PBS solution, containing the indicated concentration of polymer, by direct immersion in a CO₂/isopropanol slurry (−76° C.) for 30 seconds, followed by storage in solid CO₂ for 20 minutes, then slow thawed at 25° C. for 1 hour. This process is distinct from vitrification, which requires slow freezing—here we rapidly freeze to ensure only small ice crystals are formed, which themselves might not be toxic. The same cooling conditions were used in the IRI assays to allow us to link the observed cryopreservation with the important ‘antifreeze’ effect. The slow thawing strategy was chosen to ensure extensive ice recrystallisation occurred (as would be the case with large volume samples such as tissues/organs). Following thawing, intact cells were removed by centrifugation and the amount of haemoglobin released assessed by measuring the light absorbance at 450 nm. PEG and dextran showed no cryoprotective effect, with less than 3% of red blood cells being recovered (FIG. 5). PVA (31 kDa) showed limited cryoprotective effect with 15% of red blood cells being recovered at the optimum concentration of 1 mg·mL⁻¹. In contrast, the 9 kDa PVA gave a remarkable increase in cellular recovery with over 40% of the red blood cells being recovered at 1 mg·mL⁻¹ of PVA. This corresponds to only 0.1 wt % of additive compared to vitrification solutions which typically require >40 wt % concentrations to achieve cryostorage. Removal of solvents post-vitrification also leads to additional haemolysis and increases the processing burden. Concentrations of 9 kDa PVA above 1 mg·mL showed a slight decrease in recovery, as did the use of 31 kDa PVA which might indicate the onset of dynamic ice shaping and hence the formation of needle-like crystals. 85 kDa PVA, which has even more potent IRI was also evaluated for cryopreservation but <5% cellular recovery was observed at 1 mg·mL⁻¹, which was the highest concentration attainable due to solubility limits. This was attributed to the polymer irreversibly precipitating during the freezing process, forming large gel-like particles. The results not only show that simple polymeric recrystallisation inhibitors can improve cryostorage, but also serve to highlight the challenges associated with linking macroscopic effects (IRI) to cryopreservation.

### Example 3

### Role of PVA

A further set of experiments was devised to demonstrate the exact role of PVA. A second, slow freezing strategy was employed (<5° C.·min⁻¹) to ensure ice was preferentially formed in the extracellular spaces, which promotes dehydration of the cells through osmotic stress. (One may again highlight here that no vitrification is used). Under these conditions the major source of cell death will not be recrystallisation during thawing and therefore addition of IRI-active compounds or the rate of thawing should have no effect.

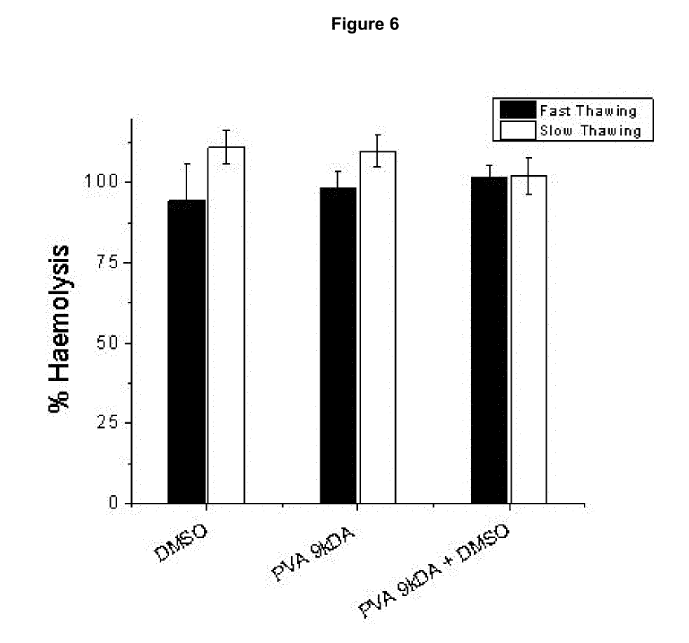

FIG. 6 shows recovery rates for slow freezing combined with slow/fast thawing and was compared to 1% DMSO. None of the additives had any effect on cellular recovery under these conditions demonstrating that IRI compounds enhance cryopreservation only through modulation of the thawing process and do not protect during freezing.

In conclusion, we have demonstrated that PVA can produce recrystallisation inhibition. This unique property—to slow the rate of ice crystal growth—was exploited to enable partial cryopreservation of red blood cells with only 0.1 wt % of the additive, and in the complete absence of any organic solvents (i.e. vitrification free). This effectively demonstrates that modulation of the thawing process (during which there is extensive ice crystal growth) is a powerful route to improving cellular cryopreservation protocols and may allow for the reduction, or removal of organic solvents from cryopreservation.

### Example 4

### Visualisation of Effect of Freezing Temperature on Ice Crystal Size

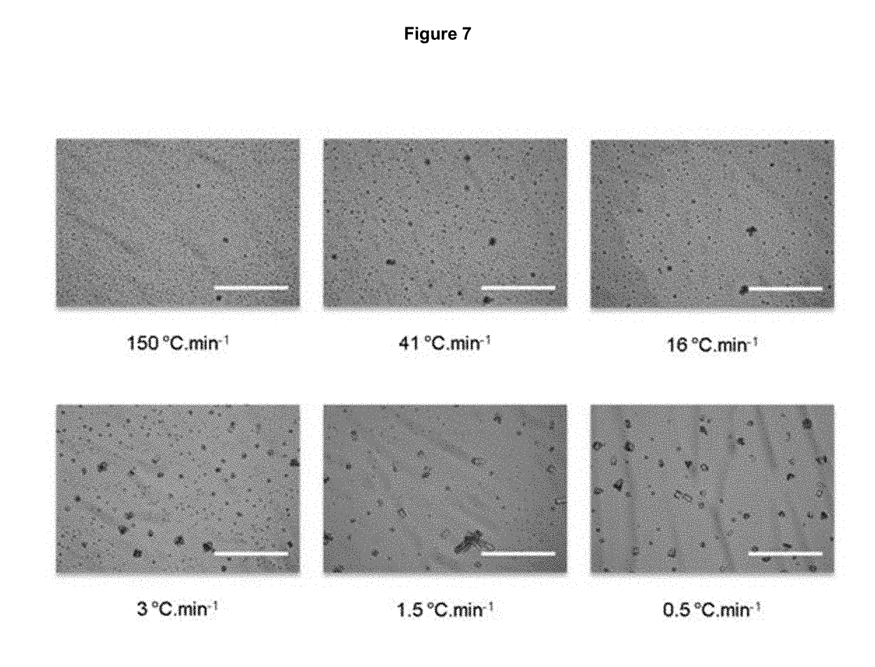

Phosphate buffered saline (as used in the cryopreservation) was frozen between two glass coverslips at various rates from 4° C. down to −76° C. using a liquid nitrogen cooled microscope stage. The ice was photographed as soon as the temperature reached −76° C. This is shown in FIG. 7.

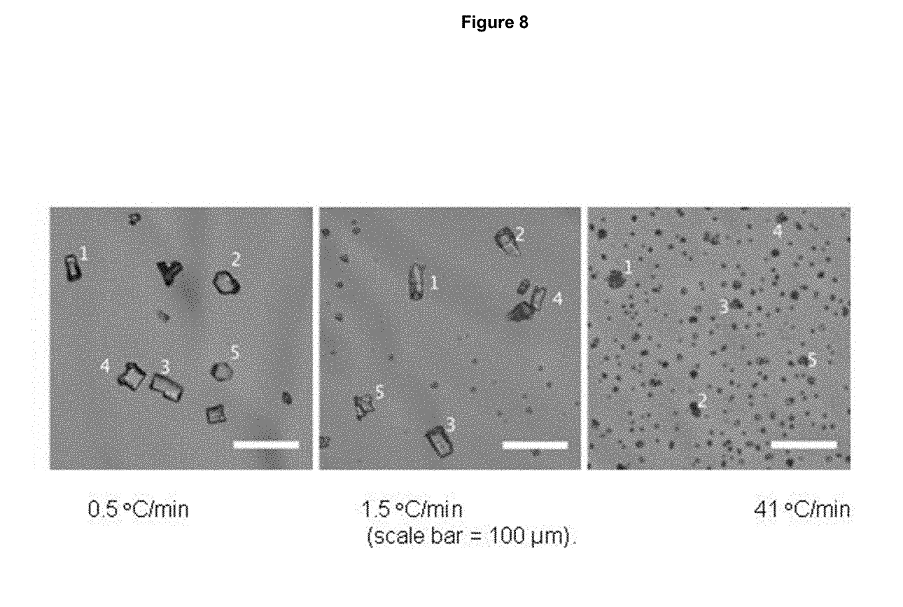

FIG. 8 shows that rapid cooling gives smaller crystals.

1. A method of reducing cell damage during the warming or thawing of a cryopreserved composition comprising blood cells, the method comprising the step:
(i) warming or thawing the cryopreserved composition comprising the blood cells,
wherein the composition comprises polyvinyl alcohol (PVA) having a weight average molecular weight of from 6-14 kDa, and wherein the composition is substantially free of vitrification-inducing agents.

2. (canceled)

3. A method of reducing cell damage during the warming or thawing of a cryopreserved composition comprising biological material, the method comprising the step:
(i) warming or thawing the cryopreserved composition comprising the biological material,
wherein the composition comprises polyvinyl alcohol (PVA) having a weight average molecular weight of from 6-14 kDa, and wherein the composition is substantially free of vitrification-inducing agents such that the composition is not capable of forming a non-crystalline glass-phase.

4-5. (canceled)

6. A method as claimed in claim 3, wherein the cryopreserved composition comprises ice crystals which are less than 20 μm in length.

7. A method as claimed in claim 3, wherein the temperature of the composition was or is reduced to the cryopreserving temperature at a rate which induced or induces the production of small ice crystals in the composition.

8. A method as claimed in claim 3, wherein the temperature of the composition was or is reduced to the cryopreserving temperature at a fast rate of at least 10° C./minute.

9.-11. (canceled)

12. A method as claimed in claim 3, wherein the biological material comprises one or more cells, a tissue, a whole organ or a part of an organ.

13. A method as claimed in claim 3, wherein the biological material is or comprises semen, blood cells, stem cells, tissue samples, skin grafts, oocytes, embryos, ovarian tissue or plant seeds or shoots.

14. A method as claimed in claim 3, wherein the weight average molecular weight of the PVA is in the range of 7-13 kDa.

15. A method as claimed in claim 3, wherein the concentration of the PVA in the composition is insufficient to prevent ice nucleation in the composition.

16. A method as claimed in claim 3, wherein the concentration of the PVA in the composition is 0.5 mg/mL to 2.5 mg/mL.

17. A method as claimed in claim 3, wherein vitrification-inducing agents are ethylene glycol, glycerol, DMSO and/or trehalose.

18.-23. (canceled)

24. A method as claimed in claim 3, wherein the weight average molecular weight of the PVA is in the range 8-12 kDa.

25. A method as claimed in claim 3, wherein the weight average molecular weight of the PVA is in the range 9-11 kDa.

26. A method as claimed in claim 3, wherein the concentration of the PVA in the composition is 0.5 mg/mL to 10 mg/mL.
